(19) United States
(12) Patent Application Publication
(10) Pub. No.: US 2026/0366269 A1
(43) Pub. Date: Nov. 19, 2026

(54) SYSTEM AND METHOD FOR DETECTING INSTALLATION OF UNDERCARRIAGE TRACK ON A WORK MACHINE

(71) Applicant: Caterpillar Inc., Peoria, IL (US)

(72) Inventors: Li Zhang, Dunlap, IL (US); Zhiyong Hu, Chicago, IL (US); Eric James Johannsen, Washington, IL (US)

(73) Assignee: Caterpillar Inc., Peoria, IL (US)

(21) Appl. No.: 19/208,718

(22) Filed: May 15, 2025

(51) Int. Cl. E02F 9/26

(52) U.S. Cl. CPC E02F 9/268

(57) ABSTRACT

A work machine, such as a dozer, generates vibration data indicative of vibrations caused by motion of a continuous ground-engaging track in its undercarriage. A system including an electronic controller for the work machine or a separate vibration assessor receives and evaluates the vibration data to identify a rate of change over time that exceeds a predetermined threshold. Filtering the vibration-slope data based on when the machine was in proximity to a workshop capable of replacing the track enables the system to estimate when a last replacement event for the track took place and to cause an action for servicing the undercarriage before failure occurs.

### TECHNICAL FIELD

The present disclosure relates generally to a system and method for detecting installation of undercarriage track on a work machine, and more specifically, to evaluating vibration data detected on a work machine to identify when an undercarriage track was replaced.

### BACKGROUND

Work machines, such as tractors, skid steers, dozers, and excavators, often have a continuous ground-engaging track on the left and right sides of the machine within an undercarriage. These tracks help provide traction to propel the machine and are typically formed as interconnected links pinned together into a looped chain. Depending on the implementation, track shoes within the track may have grousers to help enhance the ground traction. A drive sprocket on the machine has teeth that engage with the chain and cause the track to rotate around one or more idler wheels and track rollers for forward or reverse movement of the machine.

Components of the undercarriage track, such as e.g., track links, bushings, and/or pins, wear over time, requiring their adjustment, reconditioning, or replacement to avoid failure. One technique for detecting wear involves manually inspecting the components and measuring their dimensions. For the components to be inspected and measured, the machine must be immobilized, which can decrease productivity at a work site. Moreover, personnel time is expended traveling to the machine, making the manual measurements, and evaluating the results. Additionally, the status of component wear is available only as often as personnel visit the equipment and perform the inspection and measurements.

To avoid the disruptions of manual measurements, track wear may alternatively be predicted from machine behavior. The wear condition of the undercarriage, together with various factors, can impact vibration of an operating work machine. Distinguishing vibration caused by components in an undercarriage from other factors and evaluating a spectrum of the vibration data with respect to historical wear data can help predict the wear condition or wear rate of one or more track components. Deciding when to repair or replace the one or more track components, however, can also depend on when the track was installed, i.e., the age of the track. Without accessing installation records, conventional systems for estimating undercarriage wear cannot readily predict the life of a track component from machine behavior.

One approach for predicting conditions of an undercarriage track from machine vibrations is described in U.S. Patent App. Pub. No. 2024/0190523 (“the ’523 publication”). In the ’523 publication, at least one sensor measures vibration data associated with an endless track and, based on the vibrations, a system determines whether the endless track has a natural frequency. If the detected natural frequency exceeds a predetermined natural frequency by a threshold amount, the system concludes that the endless track is likely damaged. The ’523 publication does not address, however, determining or estimating when the endless track was last replaced from machine behavior. As a result, the system and method of the ’523 publication do not provide a desirable approach for predicting the life of an existing undercarriage track.

Examples of the present disclosure are directed to overcoming deficiencies of such systems.

### SUMMARY

In an aspect of the present disclosure, a method performed by a device includes receiving vibration data identifying a measure of vibration of a work machine over a time period and calculating vibration-slope data from the vibration data, where the vibration-slope data represents a rate of change of the vibration data over the time period. The method further includes identifying a portion of the vibration-slope data exceeding a slope threshold, correlating the portion of the vibration-slope data to at least one range during the time period, and estimating a last replacement event for one or more components on the work machine causing the vibration, where the last replacement event is a time corresponding to the at least one range. Finally, an action is caused to be performed relating to servicing the one or more components based on the last replacement event.

In another aspect of the present disclosure, a system comprises a work machine and a vibration assessor comprising one or more memories and one or more processors. The vibration assessor is configured to receive vibration data identifying a measure of vibration of the work machine over a time period, where the vibration of the work machine is caused by motion of one or more components of an undercarriage track on the work machine. The vibration assessor further calculates vibration-slope data from the vibration data by dividing the vibration data by ground speed of the work machine, the vibration-slope data representing a rate of change of the vibration data over the time period. A range in the time period is identified corresponding to the vibration-slope data exceeding a slope threshold. The vibration assessor is further configured to estimate, during the time period, a last replacement event for the undercarriage track on the work machine, where the last replacement event corresponds to the range, and to cause an action to be performed relating to servicing the undercarriage track based on the last replacement event.

In yet another aspect of the present disclosure, a device includes one or more memories and one or more processors configured to receive vibration data identifying a measure of vibration of a machine over a time period, where the vibration of the machine is caused by motion of one or more components of an undercarriage track on the machine, and to calculate vibration-slope data from the vibration data, where the vibration-slope data represents a rate of change of the vibration data over the time period. The processors are further configured to identify a range on the time period corresponding to the vibration-slope data exceeding a slope threshold, to estimate, on the time period, a last replacement event for the undercarriage track on the machine, where the last replacement event corresponding to the range, and to cause an action to be performed relating to servicing the one or more components based on the last replacement event.

### BRIEF DESCRIPTION OF DRAWINGS

The detailed description references the accompanying figures. In the figures, the left-most digit of a reference number identifies the figure in which the reference number first appears. The same reference numbers indicate similar or identical items.

FIG. 1 is a diagrammatic side view of an exemplary track-type machine in accordance with an example of the present disclosure.

FIG. 2 is a line graph showing representative vibration data over time for the machine of FIG. 1 in accordance with an example of the present disclosure.

FIG. 3 is a line graph showing representative vibration slope data over time for the machine of FIG. 1 in accordance with an example of the present disclosure.

FIG. 4 is a line graph showing representative manual wear measurements over time for the machine of FIG. 1 in accordance with an example of the present disclosure.

FIG. 5 is a time series graph showing representative peaks in the vibration slope data over machine hours in accordance with an example of the present disclosure.

FIG. 6 is a flow chart depicting a representative method for estimating when an undercarriage track was installed for the machine of FIG. 1 in accordance with an example of the present disclosure.

### DETAILED DESCRIPTION

Consistent with the principles of the present disclosure, in some examples, a work machine, such as a dozer or skid steer loader, generates vibration data indicative of vibrations caused by motion of a continuous ground-engaging track in its undercarriage. A vibration assessor receives and evaluates the vibration data to identify a rate of change over time that exceeds a predetermined threshold. Filtering the vibration-slope data based on when the machine was in proximity to a workshop capable of replacing the track enables the system to estimate when a last replacement event for the track took place and to cause an action for servicing the undercarriage before failure occurs. Further processing of the vibration data, such as by evaluating the derivative of the vibration-slope data as a function of machine operating hours, can lead to enhanced identification of the last replacement event and aid in estimating a future service or replacement date. The following describes several examples for carrying out the principles of this disclosure.

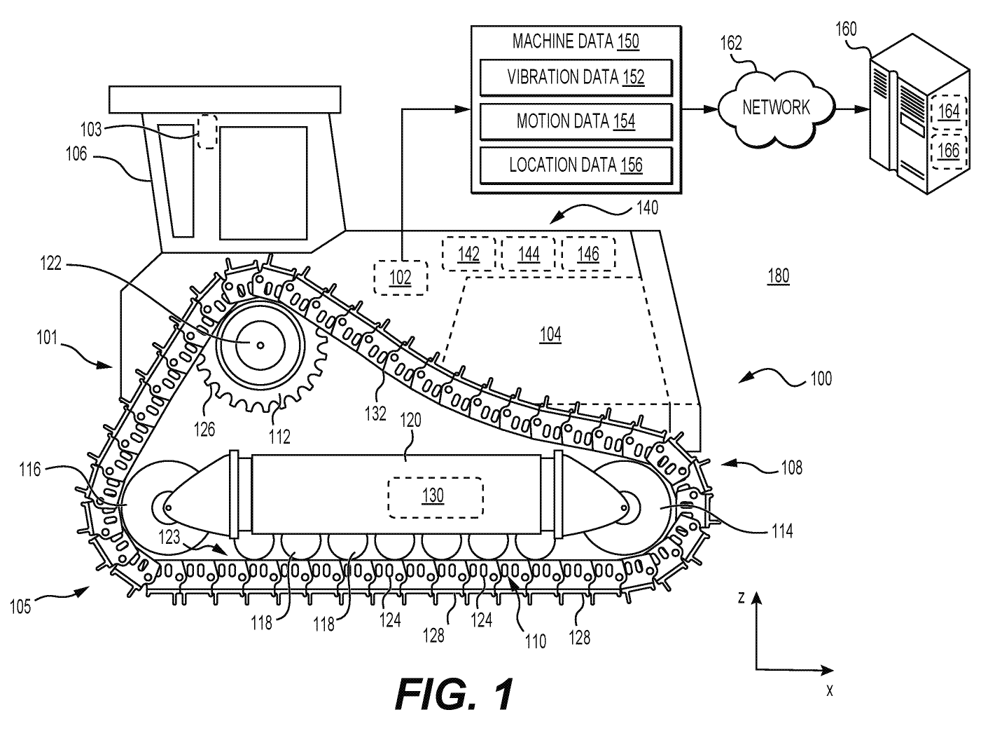

FIG. 1 illustrates an exemplary track-type machine 100 consistent with examples of the present disclosure. Track-type machine 100 may embody any machine that is driven, propelled, positioned, and/or maneuvered by operating a “continuous” or endless track-type traction device. Such machines may include, for example, track-type tractors, skid steers, dozers, excavators, backhoes, track loaders, front shovels, rope shovels, or any other type of track-maneuverable machine. Accordingly, machine 100 typically includes a work tool (not shown) for assisting in executing a function. For instance, machine 100 may cause movement of an affiliated tool depending on the need, such as a loader, bucket, pallet fork, broom, grinder, tiller, rake, blade, or auger, among others.

Machine 100 generally includes an upper body 101 supported by an undercarriage 105. Upper body 101 includes a cabin 106 configured for housing an operator of machine 100. Cabin 106 may include a workstation with various human-machine interfaces, such as controls, instruments, and indicators, useful for operating machine 100 and for receiving feedback on its behavior. An electronic control module (ECM) 102 and a communicator 103, each of which is discussed in more detail below, may reside within upper body 101 and receive, process, and send electronic information relating to the performance and configuration of machine 100, some of which may be useful for the operator within cabin 106.

Upper body 101 further includes an engine 104. Otherwise termed a power source, the engine produces and delivers mechanical power for operating various functions of machine 100, such as the power necessary to propel machine 100 and to operate various actuators and systems of machine 100. Typically, engine 104 is an internal combustion engine such as, for example, a diesel engine, a gasoline engine, an electric-gas hybrid engine, or any other configuration of engine known to one skilled in the art. Alternatively or additionally, driving mechanism 122 may embody an electric motor, electrically coupled to an electric power source and configured to convert at least a portion of the electrical energy into mechanical energy. According to yet another example, engine 104 may include a hydraulic motor fluidly coupled to a hydraulic pump and configured to convert a fluid pressurized by the pump into a torque output. Other features of the engine may include a fuel system, an exhaust system, and a cooling system, which are excluded from illustration and discussion solely for purposes of simplicity.

In the example of FIG. 1, engine 104 within upper body 101 propels machine 100 by causing movement of at least a track assembly 108 within undercarriage 105. As a right-side view, FIG. 1 shows only a single track assembly 108. At least a second track assembly corresponding to track assembly 108 would typically be positioned on the left side of machine 100 as well. In general, track assembly 108 includes a track 110, a drive sprocket 112, a front idler 114, a rear idler 116, multiple track rollers 118, and a frame assembly 120. These components of track assembly 108 are exemplary only and not intended to be limiting. Accordingly, track assembly 108 may include additional and/or different components than those listed above.

Engine 104 of machine 100 transmits power to drive sprocket 112 via a driving mechanism 122. Driving mechanism 122 may include a mechanical drive, a hydraulic drive, an electric drive, or a combination thereof. Drive sprocket 112 may be coupled to driving mechanism 122 via a shaft (not shown), which may provide an interface for delivering torque generated by engine 104 and driving mechanism 122 to rotate drive sprocket 112. For example, drive sprocket 112 may be secured (e.g., welded, bolted, heat-coupled, etc.) to a hub associated with a shaft (not shown), so that drive sprocket 112 rotates in response to the torque generated by driving mechanism 122. In some examples, drive sprocket 112 may be directly coupled via a drive shaft to driving mechanism 122. Alternatively, drive sprocket 112 may be coupled to the driving mechanism via a torque converter (such as a gearbox, transmission, etc.), so that rotation of drive sprocket 112 is proportional to the torque generated by driving mechanism 122.

Track 110 forms a continuous or endless loop structure as a ground-engaging portion of machine 100. Track 110 is operatively coupled to drive sprocket 112, front idler 114, rear idler 116, and track rollers 118. In general, rotation of drive sprocket 112 causes track 110 to move around a periphery or circumference of drive sprocket 112, first idler 114, track rollers 118 and rear idler 116 to engage the ground and thereby propel machine 100 in a manner known in the art. Clockwise rotation of drive sprocket 112 and track 110 in FIG. 1 will cause a forward movement of machine 100 (left to right in FIG. 1 along the X axis), while counterclockwise rotation of drive sprocket 112 and track in FIG. 1 will cause a reverse movement of machine 100 (right to left in FIG. 1 along the –X axis).

Track 110 contains a number of components. In one example, track 110 includes a chain 123 formed from a plurality of interconnected track links 124. It should be understood that “track link,” as used herein, refers to any linkage component of a continuous chain for a track-type machine. In one example, adjacent (e.g., consecutive) track links 124 may be coupled together via a plurality of track pin assemblies described further below. The track links 124 are engaged by teeth 126 of drive sprocket 112 to drive chain 123 of track 110 around drive sprocket 112, front idler 114, rear idler 116, and track rollers 118. In the example of FIG. 1, track 110 will have a length generally determined by the path of traversal around drive sprocket 112, front idler 114, track rollers 118, and rear idler 116 for machine 100.

Track 110 within track assembly 108 may include a plurality of track shoes 128. Each track shoe 128 may include a connecting portion configured to be secured to one or more track links 124 and a ground-engaging portion configured to contact the ground. The ground-engaging portion may include one or more features (e.g., grouser bars) that provide increased traction between track shoes 128 and the ground. It should be understood, however, that any type of track shoe forming a part of a track assembly used by a track-type mobile machine may be implemented consistently with the present disclosure. In some examples, track shoes 128 may be integrally formed with track links 124. In other embodiments, track shoes 128 may be omitted entirely from track assembly 108, so that surfaces of track links 124 that would otherwise contact track shoes 128 may contact the ground surface under machine 100.

As mentioned above, ECM 102 provides centralized processing and control as an electronic controller for work machine 100. The term “controller” is meant to be used in its broadest sense to include one or more controllers and/or microprocessors that may be associated with machine 100 and that may cooperate in controlling various functions and operations of the machine. The functionality of ECM 102 may be implemented in hardware and/or software without regard to the functionality. ECM 102 may include or be coupled to a memory (not shown), which may store instructions or algorithms in the form of data, and a processing unit, which may be configured to perform operations based upon the instructions. The memory may be any suitable computer-accessible or non-transitory storage medium for storing computer program instructions, such as RAM, SDRAM, DDR SDRAM, RDRAM, SRAM, ROM, magnetic media, optical media and the like.

ECM 102 may be a single controller or multiple controllers working together to perform a variety of tasks. ECM 102 may embody a single or multiple microprocessors, field programmable gate arrays (FPGAs), digital signal processors (DSPs), and/or other components configured to generate a compaction plan, one or more travel paths for work machine 100 and/or other information useful to an operator of work machine 100. Numerous commercially available microprocessors can be configured to perform the functions of ECM 102. Various known circuits may be associated with ECM 102, including power supply circuitry, signal-conditioning circuitry, actuator driver circuitry (i.e., circuitry powering solenoids, motors, or piezo actuators), and communication circuitry. In some examples, ECM 102 may be positioned on work machine 100, while in other examples ECM 102 may be positioned at an off-board location and/or remote location relative to work machine 100.

Machine 100 further includes a sensor system 140 containing various devices for detecting physical characteristics of the machine, such as its position, movement, and location. In some examples, sensor system 140 includes a vibration sensor 142 configured to detect vibrational movement of machine 100 in its three-dimensional space, i.e., movement along the vertical Z axis, along the latitude Y axis, and along the longitude X axis in FIG. 1. Vibration sensor 142 may be an inertial measurement unit (IMU) that contains an accelerometer configured to sense and generate vibration data 152 indicative of movement in at least these three degrees of freedom that collectively correlate to vibration or shaking of at least upper body 101 over time.

In some examples, sensor system 140 also includes a motion sensor 144 configured to detect translational movement of machine 100. Motion sensor 144 may include one or more devices, such as an accelerometer, a tachometer, a speedometer, and/or an IMU, that sense the speed associated with machine 100 (e.g., speed of engine 104 and/or speed of track 110) and generate motion data 154 identifying the speed associated with machine 100 across a ground surface. In some implementations, motion sensor 144 may further sense an acceleration of machine 100 and may generate acceleration data within motion data 154 identifying the acceleration of machine 100 across a ground surface. Motion sensor 144 may further sense a traveling direction of machine 100 and may generate direction data within motion data 154 identifying the traveling direction of machine 100.

Additionally, sensor system 140 may include a location sensor 146 configured to detect a position of machine 100 within a coordinate system at any point in time. Location sensor 146 may include a global navigation satellite system (GNSS), including a global positioning system (GPS) receiver, a local positioning system (LPS) device (e.g., that uses triangulation, multi-lateration, etc.), and/or the like. In some examples, location sensor 146 will generate location data 156 indicative of the position of machine 100.

As shown in FIG. 1, ECM 102 may control and collect machine data 150 from sensor system 140 and share some or all of that data with a computing system referred to as vibration assessor 160 that, in some examples, is situated remotely from machine 100. ECM 102 may communicate directly with vibration assessor 160, or machine 100 may route communications through communicator 103, which may accomplish longer range connections. For example, while machine 100 is operating within a worksite, vibration assessor 160 can be located at a back office or other location that is remote from machine 100, or that is remote from the worksite overall. As illustrated in FIG. 1, vibration assessor 160 can communicate wirelessly with at least machine 100 via a network 162.

Vibration assessor 160 can be one or more servers, computers, or other off-board computing devices. As such, vibration assessor 160 may include one or more processors 164, which may be implemented in hardware, firmware, and/or a combination of hardware and software. The one or more processors 164 may include a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component.

In some examples, vibration assessor 160 includes one or more memories 166. These memories may include a random-access memory (RAM), a read-only memory (ROM), and/or another type of dynamic or static storage device (e.g., a flash memory, a magnetic memory, and/or an optical memory) that stores information and/or instructions for use by one or more processors 164 to perform a function, as discussed in more detail below.

In some implementations, vibration assessor 160 may be implemented by one or more computing resources of a cloud computing environment. For example, vibration assessor 160 may be hosted in the cloud computing environment. Alternatively, vibration assessor 160 may be non-cloud-based or may be partially cloud-based.

Vibration assessor 160 coupled with machine 100, particularly through electronic control of ECM 102 for evaluating machine data 150, may be viewed collectively as a system 180 in FIG. 1. Whether processing of machine data 150 occurs within vibration assessor 160, ECM 102, or elsewhere in system 180, the processing may evaluate at least vibration data 152 to determine an estimate for when track 110 was last replaced or installed on machine 100, i.e., a last replacement event, and to use that estimate to help predict the status of wear or a life span for track 110. The use of the last replacement event may include passing that result to an algorithm executed by vibration assessor 160 that considers the date of the last replacement event together with vibration data 152 and possibly other machine data 150 in making its wear or life prediction. This use of a last replacement event with analysis that predicts component wear or life span can be beneficial at least because the wear of an undercarriage is not always or completely based on the number of operating hours. And the number of operating hours for machine 100 may not always indicate the time for repair or replacement of its undercarriage. But the knowledge or at least an estimate of when a track was last installed can help inform the prediction for a maintenance event more accurately.

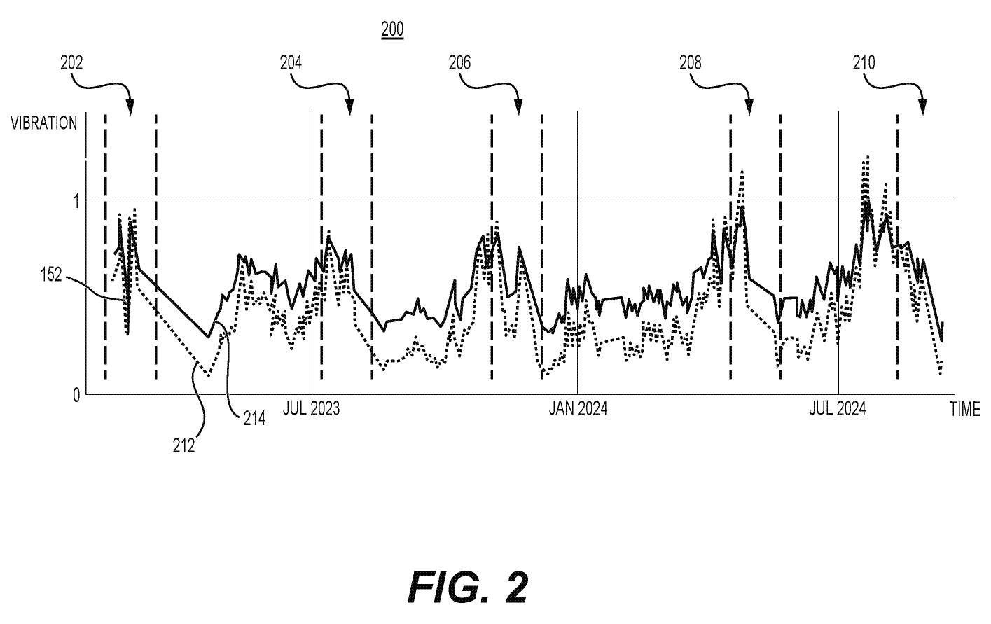

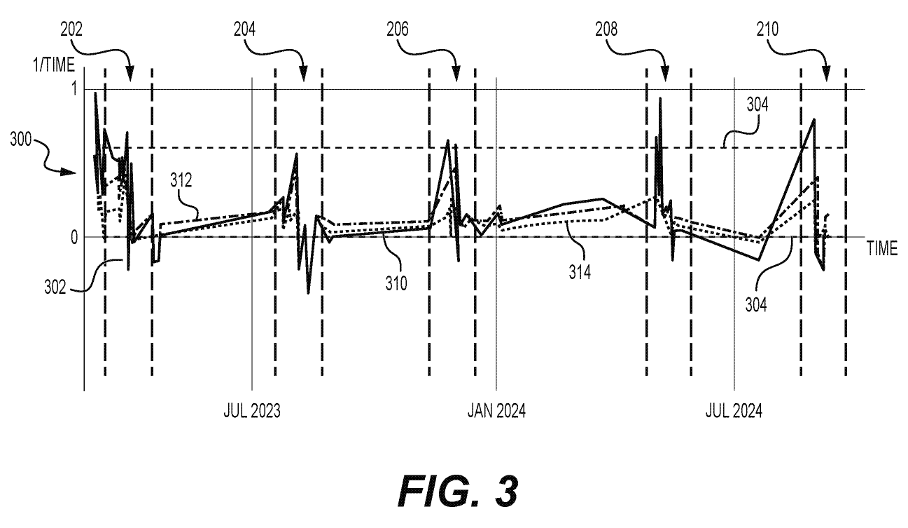

To help identify a last replacement event for track 110, one or more devices within vibration assessor 160, such as one or more processors 164 and one or more memories 166, may be configured to receive vibration data 152 from sensor system 140 and to determine a rate of change of the vibration data 152 over time as indicative of a replacement event for track 110. When considered graphically, vibration assessor 160 is configured to analyze the slope of a curve representing vibration data 152, as explained below with respect to FIGS. 2-3.

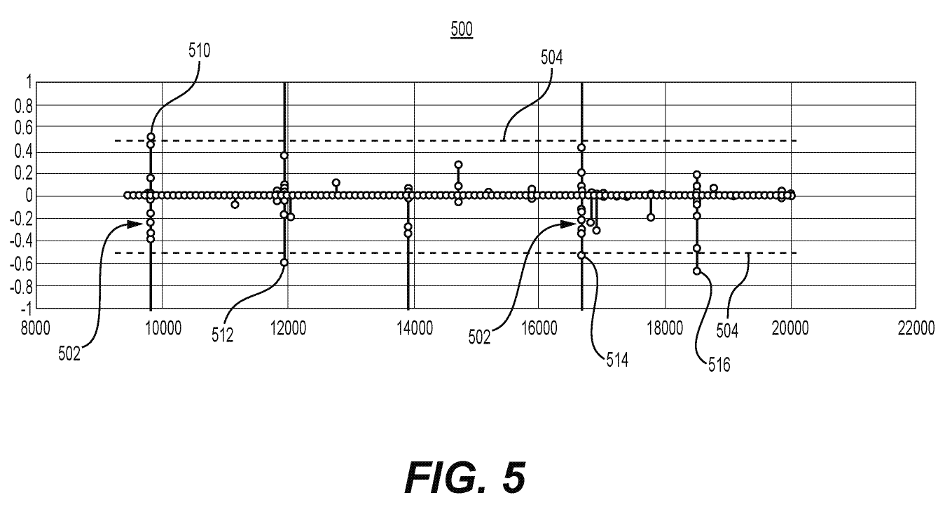

FIG. 2 illustrates a vibration graph 200 showing an example of vibration data 152 as a function of real (calendar) time for machine 100 while in operation. In other examples, however, vibration data 152 may be assessed according to the passage of time during the operation of the machine, e.g., machine hours, regardless of the passage of calendar time (see, e.g., FIG. 5). In FIG. 2, vibration data 152 has been collected during operation of machine 100 over several years and plotted on a continuous time scale, roughly from about Jan. 2023 to about Dec. 2024.

FIG. 2 depicts two line graphs indicating representations of vibration data 152 sensed by vibration sensor 142 during operation of machine 100 over the two-year time period. One line indicates the vibration amplitude 212, while the other line indicates the root-mean square of the signal, or vibration RMS 214. Vibrational movement of machine 100 can arise from many sources, such as operation of engine 104, motion of an undercarriage 105 during movement of track 110 around drive sprocket 112, engagement of a work tool with ground, the machine (ground) speed of the machine, and the type of ground surface on which the machine is moving. During most stretches of this time, such as perhaps Apr.-July 2023, August-Nov. 2023, January-Mar. 2024, and Jul.-Oct. 2024 shown in FIG. 2, the vibration data 152 is relatively stable, i.e., averaging a substantially horizontal value across vibration graph 200. During certain time ranges between these stretches, however, the vibration data 152 changes more dramatically and, particularly, includes sharp decreases. These periods are identified in FIG. 2 as first range 202, second range 204, third range 206, fourth range 208, and fifth range 210.

With respect to wear of the components associated with track 110, machine speed can directly affect the level of vibration detected by vibration sensor 142. A worn track will cause substantially more vibration than a new track for a given machine speed and may cause an increased amount of vibration comparatively at higher speeds. In accordance with the principles of the present disclosure, vibration assessor 160 senses vibration of machine 100, such as upper body 101, and evaluates that vibration as a function of the speed of the machine. In particular, vibration assessor 160 receives vibration data 152 from machine 100 and processes the data to identify a rate of change of the vibration data 152 using machine speed to help identify changes in the wear condition of track 110. As known to those of skill in the field, a rate of change of data over time equates with a slope of the data graphically. Thus, vibration assessor 160 will process vibration data 152 to calculate a corresponding slope of the vibration data over time and does so by dividing vibration data 152 by machine speed, for example as contained in motion data 154 detected by motion sensor 144.

While FIG. 2 depicts vibration data 152 over time, FIG. 3 illustrates the results of calculations of vibration assessor 160 on vibration data 152 to generate vibration-slope data 302 within a vibration-slope graph 300 as a function of time. Generated by dividing vibration data 152 by machine speed at a given time, vibration-slope data 302 in FIG. 2 has the units of 1/time, or in the context of FIG. 2, 1/hours (hours⁻¹). These units, which are essentially frequency, represent the rate of change of vibration and are plotted in FIG. 3 on a calendar-time scale across about two years. FIG. 3 includes data generated from the detection of vibration in three orthogonal dimensions, or channels, by an IMU associated with vibration sensor 142, designated as first-channel data 310, second-channel data 312, and third-channel data 314. Spikes within the vibration slope for each of these channels on vibration-slope graph 300 represent areas of a very high rate of change for vibration data 152 compared with other vibration data 152 over the relevant time period when factoring in machine speed. It will be appreciated that more or fewer sources of vibration data may be included within the assessment other than first-channel data 310, second-channel data 312, and third-channel data 314. As shown by the regions segregated with vertical lines, the various spikes in vibration-slope data 302 occur within first range 202, second range 204, third range 206, fourth range 208, and fifth range 210.

In some examples, vibration assessor 160 is further configured upon calculating vibration-slope data 302 from vibration data 152 to compare the vibration-slope data 302 to a predetermined threshold. The predetermined threshold may be any level of vibration slope above which vibration-slope data 302 may indicate that a change was made to one or more components of track 110. The predetermined threshold may be determined in many ways, such as by observing vibration-slope data 302 experimentally for machine 100 or other machines and identifying a level of vibration-slope data 302 exceeded when track 110 is replaced. For instance, observing data for machine 100 or a similar machine may reveal that spikes in vibration-slope data 302 in FIG. 3 that rise upwardly more than 0.6 or drops negatively below -0.6 on the vertical scale of FIG. 3 correspond with track 110 being replaced. FIG. 3 contains slope thresholds 304 at values of 0 and 0.6 to help show that the spikes within each of the ranges either rise or fall more than a value of 0.6, exceeding the threshold for vibration-slope data 302. In some examples, a predetermined threshold may be identified as an amount of vibration slope in terms of a frequency based on the units of 1/time, such as 1/hours (hours⁻¹). It will be appreciated that the predetermined threshold indicating a replacement of track 110 may be different based on the size and type of machine and the size and type of components within track 110, such that slope thresholds 304 may vary accordingly by machine.

In processing vibration data 152, vibration assessor 160 may conclude that a change in vibration data 152 at a rate in excess of slope thresholds 304, for example, indicates a moment in which a change in vibration caused by track 110 of machine 100 was sufficiently severe so as to indicate a replacement or installation of track 110. As bushings and other components within track 110 wear due to the high stresses incurred during operation, track 110 will cause increased amounts of vibration on upper body 101 over time. In contrast, a newly installed track, lacking the wear that has occurred during extensive use, will exhibit lower amounts of vibration on upper body 101. Accordingly, comparatively high levels of vibration-slope data 302, derived from vibration data 152 as a function of machine speed, can be correlated to a significant change in the vibration data 152 caused by a change in track 110. Furthermore, by capturing vibration data 152 and calculating vibration-slope data 302 over time, vibration assessor 160 can estimate when during the life of machine 100 the track 110 was installed or replaced, whether on a scale of real time, machine hours, or some other time standard. Similarly, vibration-slope data 302 can also be configured to estimate, as needed, the age of track 110, i.e., the duration from installation of track 110 to the current time.

Referring again to FIG. 3, the calculation by vibration assessor 160 that vibration-slope data 302 includes spikes of sufficient magnitude within each of first range 202, second range 204, third range 206, fourth range 208, and fifth range 210 indicates that track 110 was likely replaced during those times. As indicated by the time scale, each of those ranges covers several weeks. During that period, it is likely that machine 100 was within a shop for maintenance and underwent various procedures that affected its vibrational movement. For example, the replacement of a track can take several days and may include other maintenance or repair work to a machine. As a result, on a calendar-time scale, machine 100 may exhibit large variations in vibration data 152 during the several weeks within ranges 202-210 that the machine is worked on in the shop and track 110 is replaced. Outside of ranges 202-210 in FIG. 3, vibration-slope data 302 generally shows more stable or consistent behavior, likely during operation of machine 100 on a work site. Therefore, vibration assessor 160 can estimate from these results that track 110 was replaced for machine 100 within the calendar periods represented by one or more of first range 202, second range 204, third range 206, fourth range 208, and fifth range 210. It will be appreciated that a scale other than calendar time may be used to assess vibration-slope data 302, as shown in FIG. 3, such as machine hours. In some examples, vibration assessor 160 may use the most recent replacement event to help predict the current wear on track 110 and its life span going forward, as discussed further below.

In some examples, vibration assessor 160 evaluates other aspects of machine data 150, such as location data 156 to refine its estimation of when track 110 was replaced. Location data 156 may include GPS data related to the position or location of machine 100 at different times. As such, in some examples, vibration assessor 160 is configured to correlate that information within location data 156 with the high occurrences of vibration-slope data 302 illustrated in FIG. 3. The location data 156 may indicate that machine 100 was present within a facility equipped to replace undercarriage tracks at about the time that the high levels of vibration-slope data 302 were captured, such as most recently within fifth range 210. The one or more memories 166 of vibration assessor 160 may store a database of these facilities and their geographic locations. In other examples, vibration assessor 160, communicator 103, or other equipment may access information relating to the location of the qualified facilities for use by vibration assessor 160. In short, location data 156 may serve as a confirmation on the estimations by vibration assessor 160 of when track 110 was replaced.

In other examples, vibration assessor 160 accesses location data 156 prior to, or in conjunction with, calculating vibration-slope data 302 to help reduce the amount of data to process. In this way, only vibration data 152 corresponding to when machine 100 was at or near a facility equipped to replace undercarriage tracks could be selected for analysis by vibration assessor 160 to determine vibration-slope data 302.

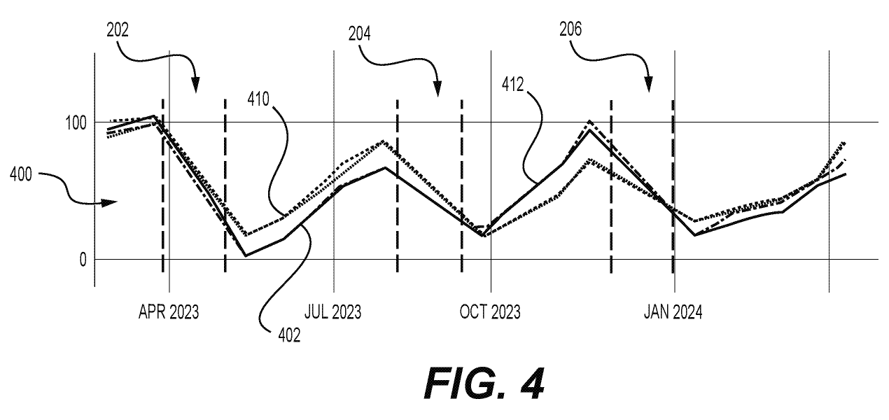

As confirmation of the estimation performed on vibration data 152 by vibration assessor 160 that resulted in vibration-slope data 302, FIG. 4 illustrates a corresponding graph of manual-measurement results 400 of wear on track 110 over a portion of the same periods of time. As shown, manual-measurement results 400 are line graphs connecting data points of wear measurements on bushings and track links within undercarriage 105. The measurements of a percentage amount of wear were taken at different points in time along the horizontal axis and then those data points were connected to show trends, namely, bushings data 410 (from left and right sides of the machine) and track links data 412 (from left and right sides of the machine). The manual-measurement results 400 include periods of increasing wear 402 between first range 202 and second range 204 and again between second range 204 and third range 206. Following each of the first range 202, second range 204, and third range 206, the amount of measured wear dropped significantly from close to 100% to near 0%, substantiating the estimate that track 110 was replaced during each of those periods. The wear was measured as a maximum at the beginning of first range 202 when machine 100 entered a shop for track replacement and then not measured again until after the track was replaced. As a result, the amount of wear is depicted as a gradual sloping line connecting those measurements across first range 202 rather than a step change (and similarly across second range 204 and third range 206).

In further examples, vibration assessor 160 is configured to provide additional processing to vibration-slope data 302 in order to identify the peaks of the rate of change of vibration data 152 over time. Specifically, vibration assessor 160 may be configured to take the derivative of vibration-slope data 302, which will result in the instantaneous rate of change at different points in time for the vibration-slope data. Vibration assessor 160 may then filter these derivatives to isolate the most extreme situations and determine ones that exceed a second threshold value. FIG. 5 illustrates this example.

FIG. 5 is a peak-slope graph 500 showing representative peaks in vibration-slope data 302, such as in FIG. 3, attained by having vibration assessor 160 take the derivative of the slope data across a scale of machine hours. As shown, the calculations result in discrete points in peak-slope graph 500 that are referred to in this disclosure as peak-slope data 502, having units of 1/sec². The peak-slope data 502 are normalized to span a vertical scale from -1.0 to +1.0 in the graph according to machine hours (i.e., operating hours for machine 100 along the horizontal axis). In most instances during the machine hours, peak-slope data 502 is at or near a value of zero along the horizontal axis. Several of the examples of peak-slope data 502, however, are clustered in the graph at around 10000 hours, 12000 hours 14000 hours, 16500 hours, and 18500 hours. Because FIG. 5 is a plot according to machine hours, the clusters of peak-slope data 502 indicate instantaneous rates of change in vibration at roughly the same time in machine hours, although they could have occurred days or weeks apart from each other. For example, for the first set of vertical data just before 10000 hours, machine 100 could be present in repair shop having various operations performed, which may occur sporadically over several days but with little difference in machine hours, resulting in points of peak-slope data 502 approximately aligned vertically in FIG. 5.

In the example of FIG. 5, vibration assessor 160 compares the results of the derivative for vibration-slope data 302 with peak thresholds 504. As with slope thresholds 304 in FIG. 3, peak thresholds 504 are predetermined levels that indicate a situation in which vibration caused by track 110 of machine 100 was sufficiently severe as to indicate a replacement or installation of track 110. Peak thresholds 504 may be determined in many ways, such as by observing vibration-slope data 302 and/or peak-slope data 502 experimentally for machine 100 or other machines and identifying a level of peak-slope data 502 exceeded when track 110 is replaced. For instance, observing data machine 100 or a similar machine may reveal that values of peak-slope data 502 in FIG. 5 beyond a certain level on the vertical scale of 0 to 1.0 of FIG. 5 correspond with track 110 being replaced. FIG. 5 contains peak thresholds 504 at values of +0.5 and -0.5 based on experimentation for machines similar to machine 100. In some examples, a predetermined threshold for peak-slope data 502 may be identified as a value based on the units of 1/time². With vibration assessor 160 comparing the vibration-slope data 302 to peak thresholds 504, the example of peak-slope graph 500 indicates the presence of four installations or changes of track 110: replacement event 510 at roughly 10000 hours, replacement event 512 at 12000 hours, replacement event 514 at 16500 hours, and last replacement event 516 at 18500 hours.

As discussed above, vibration assessor 160 may consider location data 156 in taking the derivative of vibration-slope data 302 to obtain peak-slope data 502. For instance, if not already applied in filtering vibration data 152 or vibration-slope data 302 based on the position of machine 100 in proximity to a facility capable of replacing track 110, location data 156 and information indicating the coordinates of replacement facility may be consulted to limit the peak-slope data 502 processed to identify the replacement events 510-516.

Following identification of the date, time, machine hours, or other chronology for estimation of a previous replacement or installation of track 110, specifically last replacement event 516, vibration assessor 160 may perform additional processing on vibration data 152 to predict a time for maintenance or replacement of track 110 in a manner known to those of skill in the field. In one option, vibration assessor 160 may predict wear of components within track 110 based on an amplitude of a signal spectrum associated with motion of components of the undercarriage and historical wear data associated with the components, in conjunction with last replacement event 516, or the “start date,” for track 110. In another option, vibration assessor 160 may execute a machine learning model based on last replacement event 516 and vibration data 152, perhaps with machine data 150, to predict the amount of wear at a given time for components in the undercarriage and the expected life for track 110. In other options, vibration assessor 160 may predict the amount of wear and/or estimate a lifespan of track 110 using last replacement event 516 based on additional input from machine 100 unrelated to vibration data 152, such as machine data 150 or from sensors associated with the undercarriage of the machine.

Vibration assessor 160 may also perform an action based on the predicted wear information or estimated lifetime determined using last replacement event 516. For example, the action may include vibration assessor 160 transmitting wear information about track 110 to cause an order for one or more replacement components for track 110. In some instances, the wear information includes information identifying the one or more components and/or the one or more replacement components. The order may include causing personnel to travel to machine 100 to perform a manual measurement of wear to verify the need for repair or replacement based on the projections. Similarly, the action may include generating an alert or alarm, such as in a back office or within cabin 106 of machine 100, to notify personnel of the need for inspect, repair, or replace components within track 110 based on the estimates generated by vibration assessor 160.

Vibration assessor 160 may cause an adjustment of an operation of machine 100 based on the predicted amount of wear or lifetime of the one or more components following last replacement event 516 (e.g., when the predicted amount of wear satisfies a threshold amount of wear or the undercarriage is approaching an end of the estimated lifetime). For instance, vibration assessor 160 may cause a change of a speed of machine 100, a change of acceleration of machine 100, a change of travel direction of machine 100, a change of implement command, a change of steering command, a change of gear setting, a change of tasks, and/or another operation that may reduce a wear rate of the one or more components and prolong the life of the undercarriage or the time until the one or more components have to be repaired or replaced.

In other examples, the action includes vibration assessor 160 transmitting predicted wear information and/or estimated lifetime information to one or more devices that monitor an amount of wear of components of a plurality of machines (e.g., including machine 100). In some examples, vibration assessor 160 transmits the wear information when the amount of wear on track 110 forecasted based on last replacement event 516 satisfies a threshold amount of wear. The wear information may indicate the amount of wear of the one or more components, indicate a wear rate of the one or more components, indicate an amount of wear on the one or more components, and/or an offer associated with repairing and/or replacing the one or more components.

In some examples, vibration assessor 160 transmits the wear and/or lifetime information to cause machine 100, via ECM 102, to autonomously navigate to a repair facility. Additionally, or alternatively, vibration assessor 160 may transmit the wear and/or lifetime information to cause a calendar of a technician to be populated with an event to inspect and/or repair track 110.

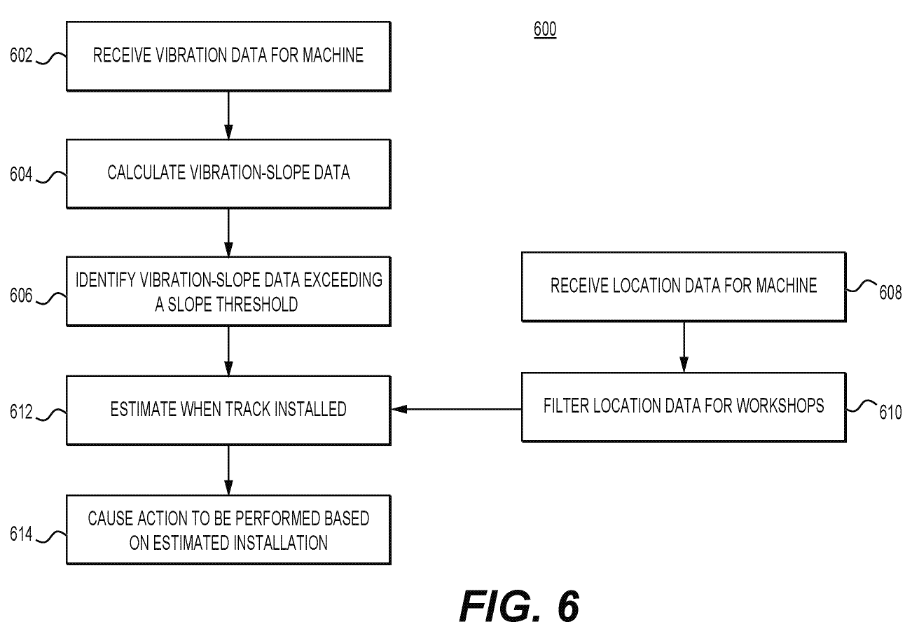

Turning from the structure and operation of system 180 including vibration assessor 160 as illustrated in FIG. 1 to a method involving this machine and system, FIG. 6 is a flowchart of a representative method for estimating when undercarriage track was installed or replaced for work machine. The example method 600 is illustrated as a collection of steps in a logical flow diagram, which represents operations that can be performed in the operation of an assessment system. The order in which the operations are described is not intended to be construed as a limitation, and any number of the described steps can be combined and performed in any order, in parallel, or simultaneously to implement the process.

Generally embodied as 600 in FIG. 6, the method begins with step 610 of receiving vibration data for a machine. As explained above with respect to FIG. 1, machine 100 may include a vibration sensor 142 within a sensor system 140 that senses movement of upper body 101, such as through channels aligned with a 3D coordinate system of the machine. As the work machine moves, shaking or vibration of its chassis is detected by vibration sensor 142. The collected vibration data may be filtered by ECM 102 or other devices such as vibration assessor 160 to distinguish vibration influenced by upper body 101 from vibrations caused by engine 104 or action of one or more work implements.

In a second step 602, vibration-slope data is calculated from the vibration data. In some examples, vibration data 152 may be transmitted from machine 100 to an external processor such as vibration assessor 160 for analysis. In other examples, analysis of vibration data 152 may be conducted within machine 100 such as by ECM 102 or affiliated devices. In analyzing vibration data 152 in one example, vibration assessor 160 determines the rate of change of vibration data 152 over time to result in vibration-slope data 302. The vibration-slope data 302 may help identify where sudden and large changes have occurred in the vibration of machine 100, as discussed above and illustrated in FIG. 3.

In a step 606 for FIG. 6, the vibration-slope data may be analyzed to identify where the slopes within the data exceed a slope threshold. FIG. 3 illustrates slope thresholds 304 within the vibration-slope data 302 as representative levels that may be used to check for large values of slope data. In the example depicted, when the slope data exceeds slope threshold 304, shown as a representative value of 0.6, the occurrences may be identified as potential evidence of a replacement event for track 110.

In another step 608 of method 600, location data for the machine may be received. Step 608 need not be sequential and follow after step 606. Indeed, in most instances, step 608 will take place continuously with the operation of machine 100 and together with steps 602, 604, and 606. As discussed above, machine 100 may collect location data 156 using a location sensor 146 as part of the sensor system 140. This location data may be GPS coordinates of machine 100, for instance, at any point in time. Other technologies or methods for identifying the position of machine 100 on a map may be employed.

In conjunction with step 608, the received location data may be filtered for locations aligned with workshops for a work machine in step 610. Installing or replacing track 110 can be a complicated task that is typically engaged in at a specialized workshop that provides servicing and maintenance for work machines. The identity and location of these workshops may be maintained in a database, such as within one or more one or more memories 166, or accessed from external sources by vibration assessor 160 or ECM 102. In step 610, the location of the workshops may be used to filter location data 156 to find when machine 100 was present within one or more of the workshops. In some examples, vibration data 152 generated when machine 100 was not in proximity to one or more of the workshops may be disregarded to minimize the amount of data to be processed.

In step 612 of FIG. 6, an estimate is made of when the undercarriage track of the machine was installed or replaced. As explained in more detail above, the combination of instances of vibration-slope data 302 exceeding slope thresholds 304 and those instances corresponding with machine 100 being at or in proximity to a workshop capable of replacing an undercarriage of a work machine may be used to isolate replacement events for track 110. For predicting future wear or life for the undercarriage, a last replacement event 516 may be selected as a baseline for analyzing when a next maintenance or replacement for track 110 should occur.

Finally, in step 614, an action may be caused to be performed based on the estimated installation or replacement determined in step 612. The actions may be varied, such as transmitting wear information about track 110 to cause an order for one or more replacement components for track 110, causing personnel to travel to machine 100 to perform a manual measurement of wear to verify the need for repair or replacement based on the projections, or generating an alert or alarm, such as in a back office or within cabin 106 of machine 100, to notify personnel of the need to inspect, repair, or replace components within track 110. Other actions are also possible based on the estimated date or machine hours at which track 110 was installed or replaced, such as last replacement event 516 determined in step 612.

Those of ordinary skill in the field will appreciate that the principles of this disclosure are not limited to the specific examples discussed or illustrated in the figures. For example, while the system has been discussed in the context of a distributed computing system having vibration assessor 160 separate from machine 100, vibration assessor 160 may be embedded within machine 100 with actions being taken to alert an operator of an impending need for service based at least in part on a determination of last replacement event 516. Also, the sequence of collecting and assessing location data 156 during the calculations of vibration data 152, vibration-slope data 302, peak-slope data 502, and other forms of machine data 150 may vary to improve the accuracy and efficiency of the calculations to estimate when track 110 was last installed or replaced.

### INDUSTRIAL APPLICABILITY

The present disclosure provides a work machine, such as a dozer, that generates vibration data indicative of vibrations caused by motion of a continuous ground-engaging track in its undercarriage. A system including a vibration assessor receives and evaluates the vibration data to identify a rate of change over time that exceeds a predetermined threshold. Further calculations to take the derivative of the slope data also can help identify instances of peak changes to vibration data. Filtering the vibration-slope data or vibration-peak data based on when the machine was in proximity to a workshop capable of replacing the track additionally enables the system to estimate when a last replacement event for the track took place.

As noted above with respect to FIGS. 1-6, a system associated with a work machine such as 100 in FIG. 1 may include a vibration assessor 160 that receives vibration data 152 identifying a measure of vibration of the machine over a time period. From the vibration data, the vibration assessor 160 can calculate vibration-slope data 302 representing a rate of change of the vibration data over the time period. Identifying a portion of the vibration-slope data that exceeds one or more of slope thresholds 304, vibration assessor 160 can correlate that portion with at least one range during the time period and estimate a last replacement event for one or more components on the machine causing the vibration. Using those results in other algorithms to predict component wear or life span, vibration assessor 160 can cause an action to be performed relating to servicing the track based on the last replacement event.

In the examples of the present disclosure, the system and method help avoid manual inspections of the undercarriage of work machines, which can be time consuming and wasteful. For those inspections, personnel often need to travel to a work site and cause the work machine to be immobilized, reducing productivity. Additionally, the personnel may conclude from the manual inspection that no servicing is currently required. The disclosed system and method avoid the need for premature and wasteful manual checks of an undercarriage.

Vibration assessor 160 also helps to increase the accuracy of existing algorithms for predicting component wear and life span. Prediction algorithms can estimate a state of wear or expected failure of a component based on vibration data, but without knowing the last replacement date for an endless track, those algorithms lack complete information for determining when failure is likely to occur. The foregoing disclosure provides non-exhaustive examples for identifying at least the last replacement date of an undercarriage track and, therefore, may avoid inaccurate assessments of when a part may need to be repaired or replaced without requiring personnel to document or otherwise store data on replacement or service histories.

Unless explicitly excluded, the use of the singular to describe a component, structure, or operation does not exclude the use of plural such components, structures, or operations or their equivalents. As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

Terms of approximation are meant to include ranges of values that do not change the function or result of the disclosed structure or process. For instance, the term “about” generally refers to a range of numeric values that one of skill in the art would consider equivalent to the recited numeric value or having the same function or result. Similarly, the antecedent “substantially” means largely, but not wholly, the same form, manner or degree, and the particular element will have a range of configurations as a person of ordinary skill in the art would consider as having the same function or result.

While aspects of the present disclosure have been particularly shown and described with reference to the embodiments above, it will be understood by those skilled in the art that various additional embodiments may be contemplated by the modification of the disclosed systems and methods without departing from the spirit and scope of what is disclosed. Such embodiments should be understood to fall within the scope of the present disclosure as determined based upon the claims and any equivalents thereof.

What is claimed is:

1. A method performed by a device, the method comprising:
receiving vibration data identifying a measure of vibration of a work machine over a time period;
calculating vibration-slope data from the vibration data, the vibration-slope data representing a rate of change of the vibration data over the time period;
identifying a portion of the vibration-slope data exceeding a slope threshold;
correlating the portion of the vibration-slope data to at least one range during the time period;
estimating a last replacement event for one or more components on the work machine causing the vibration, the last replacement event being a time corresponding to the at least one range; and
causing an action to be performed relating to servicing the one or more components based on the last replacement event.

2. The method of claim 1, further comprising:
receiving location data identifying geographic positions of the work machine over the time period;
accessing workshop-location data identifying geographic locations of workshops for replacing the one or more components; and
identifying one or more replacement locations corresponding to an intersection of the location data of the work machine and workshop-location data of the workshops.

3. The method of claim 2, further comprising:
identifying one or more sections on the time period where the location data corresponds to the one or more replacement locations; and
filtering the vibration data or the vibration-slope data based on the one or more sections.

4. The method of claim 1, further comprising:
calculating peak-slope data, comprising taking a derivative of the vibration-slope data;
identifying a portion of the peak-slope data exceeding a peak threshold within the at least one range on the time period; and
estimating the last replacement event based at least in part on the portion of the peak-slope data exceeding the peak threshold.

5. The method of claim 1, further comprising:
causing the work machine to move across a ground surface by rotating an endless track on an undercarriage, the rotating causing vibration of the work machine; and
generating the vibration data based on the vibration of the work machine.

6. The method of claim 1, wherein calculating vibration-slope data from the vibration data comprises dividing the vibration data by machine speed.

7. The method of claim 1, wherein the causing an action comprises:
transmitting predicted wear information about the one or more components to personnel, the predicted wear information being based on the last replacement event;
causing the personnel to perform a manual measurement of wear on the one or more components;
generating an alert or alarm; or
notifying the personnel of a need to inspect, repair, or replace the one or more components.

8. A system, comprising:
a work machine; and
a vibration assessor comprising one or more memories and one or more processors, the vibration assessor configured to:
receive vibration data identifying a measure of vibration of the work machine over a time period, wherein the vibration of the work machine is caused by motion of one or more components of an undercarriage track on the work machine,
calculate vibration-slope data from the vibration data by dividing the vibration data by ground speed of the work machine, the vibration-slope data representing a rate of change of the vibration data over the time period,
identify a range in the time period corresponding to the vibration-slope data exceeding a slope threshold,
estimate, during the time period, a last replacement event for the undercarriage track on the work machine, the last replacement event corresponding to the range, and
cause an action to be performed relating to servicing the undercarriage track based on the last replacement event.

9. The system of claim 8, wherein the work machine further comprises:
a location sensor configured to generate location data representative of a geographic location of the work machine during the time period; and
a vibration sensor configured to generate the vibration data.

10. The system of claim 9, wherein the vibration assessor is further configured to:
access workshop-location data identifying geographic locations of workshops for replacing the undercarriage track.

11. The system of claim 10, wherein the vibration assessor is further configured to:
identify one or more replacement locations corresponding to an overlap of the location data of the work machine and workshop-location data of the workshops.

12. The system of claim 11, wherein the vibration assessor is further configured to:
identify one or more sections within the time period where the location data corresponds to the one or more replacement locations; and
filter the vibration data or the vibration-slope data based on the one or more sections.

13. The system of claim 8, wherein the vibration assessor is further configured to:
calculate peak-slope data by taking a derivative of the vibration-slope data; and
identify a portion of the peak-slope data exceeding a peak threshold at the range on the time period.

14. The system of claim 13, wherein the vibration assessor is further configured to:
estimate the last replacement event based at least in part on the portion of the peak-slope data exceeding the peak threshold.

15. The system of claim 8, wherein the vibration assessor is further configured to:
transmit predicted wear information about the one or more components to personnel, the predicted wear information being based on the last replacement event;
cause the personnel to perform a manual measurement of wear on the one or more components;
generate an alert or alarm; or
notify the personnel of a need to inspect, repair, or replace the one or more components.

16. A device, comprising:
one or more memories; and
one or more processors configured to:
receive vibration data identifying a measure of vibration of a machine over a time period, wherein the vibration of the machine is caused by motion of one or more components of an undercarriage track on the machine,
calculate vibration-slope data from the vibration data, the vibration-slope data representing a rate of change of the vibration data over the time period,
identify a range on the time period corresponding to the vibration-slope data exceeding a slope threshold,
estimate, on the time period, a last replacement event for the undercarriage track on the machine, the last replacement event corresponding to the range, and
cause an action to be performed relating to servicing the one or more components based on the last replacement event.

17. The device of claim 16, wherein the device is further configured to:
receive location data identifying geographic positions of the machine over the time period;
access workshop-location data identifying geographic locations of workshops for replacing the undercarriage track; and
identify one or more replacement locations corresponding to a proximity of the location data of the machine and workshop-location data of the workshops.

18. The device of claim 17, wherein the device is further configured to:
identify one or more sections on the time period where the location data corresponds to the one or more replacement locations; and
filter the vibration data or the vibration-slope data based on the one or more sections.

19. The device of claim 16, wherein the device is further configured to:
calculate peak-slope data by taking a derivative of the vibration-slope data; and
identify a portion of the peak-slope data exceeding a peak threshold at the range on the time period.

20. The device of claim 19, wherein the device is further configured to:
estimate the last replacement event based at least in part on the portion of the peak-slope data exceeding the peak threshold.
